(19) United States
(12) Patent Application Publication
(10) Pub. No.: US 2015/0118946 A1
(43) Pub. Date: Apr. 30, 2015

(54) Automobile Ventilation Method

(71) Applicant: Hyundai Motor Company, Seoul (KR)

(72) Inventor: Dong Won YEON, Gyeonggi-Do (KR)

(73) Assignee: Hyundai Motor Company, Seoul (KR)

(21) Appl. No.: 14/521,064

(22) Filed: Oct. 22, 2014

(30) Foreign Application Priority Data
Oct. 30, 2013 (KR) 10-2013-0130576

(51) Int. Cl. B60H 1/00

(52) U.S. Cl. CPC B60H 1/00764; B60H 1/008; B60H 1/00821
USPC 454/75; 454/141

(57) ABSTRACT

An automobile ventilation method may include detecting a first carbon dioxide level inside a vehicle, detecting a current vehicle speed when the first carbon dioxide level is greater than a predetermined set level, and performing forced outdoor air switching when the current vehicle speed is greater than a predetermined set vehicle speed, and detecting a second carbon dioxide level inside the vehicle and activating a blower or increasing airflow when the second carbon dioxide level detected inside the vehicle exceeds a predetermined maximum allowable level, which is greater than the predetermined set level.

### CROSS REFERENCE TO RELATED APPLICATION

The present application claims priority to Korean Patent Application Number 10-2013-0130576 filed Oct. 30, 2013, the entire contents of which is incorporated herein for all purposes by this reference.

### BACKGROUND OF THE INVENTION

1. Field of the Invention

The present invention relates to an automobile ventilation method for both dehumidification and ventilation.

2. Description of Related Art

An automobile air conditioning system is a system regarded as a very important system to realize a pleasant inside environment for a vehicle.

A vehicle is typically equipped with a system for switching between indoor air and outdoor air, i.e., a blower, an air conditioner (A/C) and a heater system to keep the indoor atmosphere pleasant even with harsh conditions outside the vehicle.

Recent automobile air conditioning systems have evolved to a system that automatically keeps the indoor environment pleasant by determining the driver's need via discretion of the vehicle, compared with the past manual air conditioning system.

For example, a related art discusses a technology in which a vehicle automatically opens its sunroof to allow outdoor air to flow into the vehicle when the temperature in the vehicle exceeds a set temperature.

However, even with an air conditioning system, vehicle drivers often have moisture issues that appear on the front windshield and side windows while driving the vehicle with the blower off and thus have to turn on the A/C to remove the moisture to secure clear visibility, which degrades fuel efficiency and causes inconvenience to the driver.

Furthermore, if the driver drives the vehicle with the windows shut and the blower off for a long time, his/her exhalation increases the carbon dioxide level inside the vehicle, which may cause the driver to become drowsy.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an automobile ventilation method that assists in improvement of driver's convenience, fuel efficiency, and indoor pleasantness of a vehicle by automatically adjusting indoor humidity and carbon dioxide levels while the vehicle is operated for long periods of time even with a blower turned off

According to various aspects of the present invention, an automobile ventilation method may include detecting a first carbon dioxide level inside a vehicle, detecting a current vehicle speed when the first carbon dioxide level is greater than a predetermined set level, and performing forced outdoor air switching when the current vehicle speed is greater than a predetermined set vehicle speed, and detecting an a second carbon dioxide level inside the vehicle and activating a blower or increasing airflow when the second carbon dioxide level detected inside the vehicle exceeds a predetermined maximum allowable level, which is greater than the predetermined set level.

The forced outdoor air switching may be performed even when the current vehicle speed is less than the predetermined set vehicle speed, with an outdoor air switching ratio different from that applied during the forced outdoor air switching performed when the current vehicle speed is greater than the predetermined set vehicle speed.

The automobile ventilation method may further include determining whether the blower is currently activated before detecting the carbon dioxide level, and performing detection of the first carbon dioxide level when the blower is not currently activated.

Determining whether the blower is currently activated may include determining whether the current vehicle speed is greater than a predetermined reference speed.

Determining whether the current vehicle speed is greater than the predetermined set vehicle speed may include detecting a current indoor humidity level inside the vehicle when the current vehicle speed is greater than the predetermined reference speed.

The automobile ventilation method may further include performing forced outdoor air switching and activating the blower when the current indoor humidity level inside the vehicle is greater than a predetermined set humidity level.

Performing the forced outdoor air switching may include performing the forced outdoor air switching with the outdoor air switching ratio of 100%, when the current vehicle speed is greater than the predetermined set vehicle speed.

Performing the forced outdoor air switching may include performing the forced outdoor air switching with the outdoor air switching ratio of 50% when the current vehicle speed is less than the predetermined set vehicle speed.

The automobile ventilation method may further include detecting a third carbon dioxide level inside the vehicle after performing the forced outdoor air switching with the outdoor air switching ratio of 50%, and performing the forced outdoor air switching with a predetermined first outdoor air switching ratio that corresponds to a first outdoor air rise level when the detected indoor carbon dioxide level is greater than the first outdoor air rise level.

The automobile ventilation method may further include detecting a fourth carbon dioxide level inside the vehicle after performing the forced outdoor air switching with the first outdoor air switching ratio, and performing the forced outdoor air switching with a predetermined second outdoor air switching ratio that corresponds to a second outdoor air rise level when the detected indoor carbon dioxide level is greater than the second outdoor air rise level.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1, FIG. 2, and FIG. 3 are flowcharts illustrating an exemplary automobile ventilation method, according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

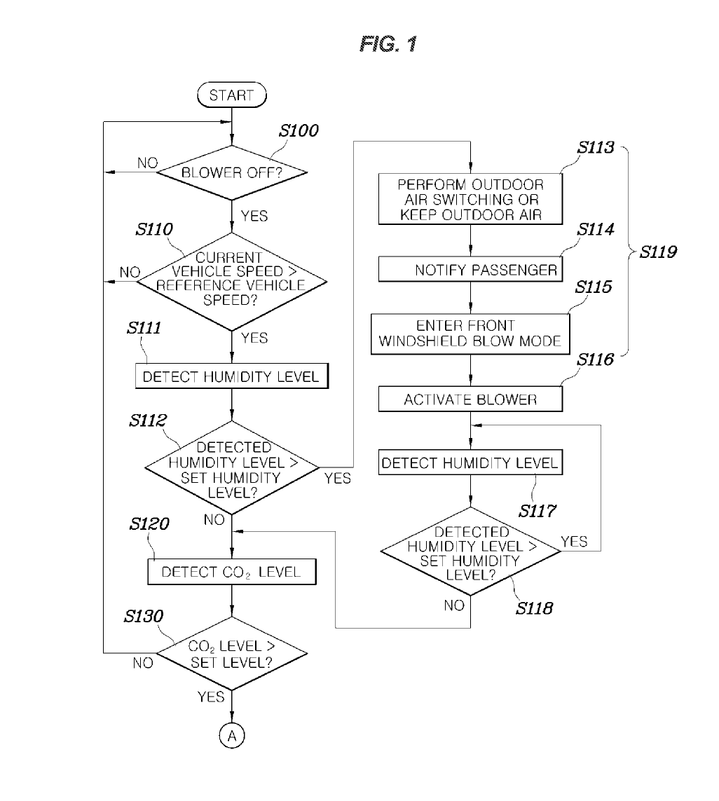

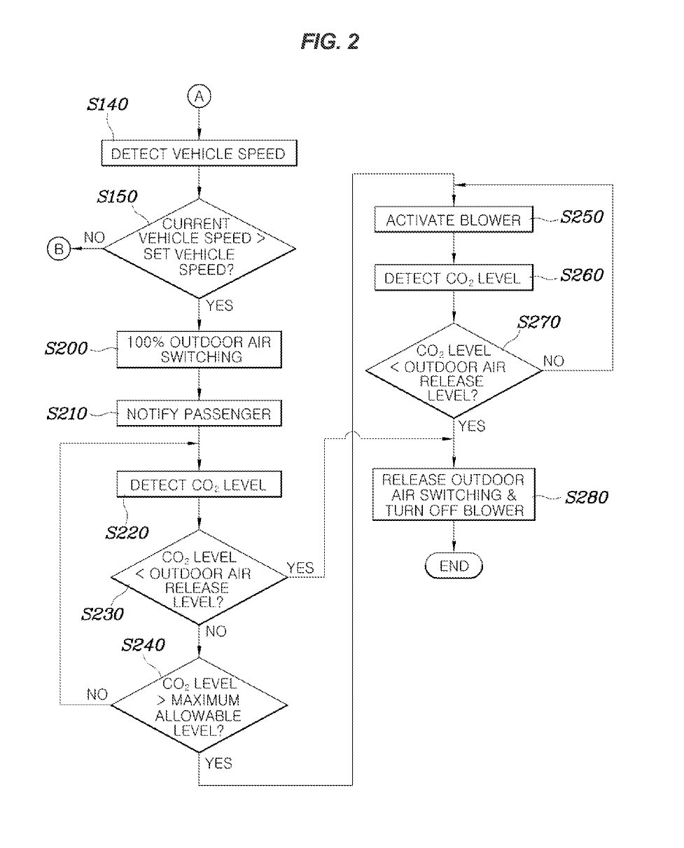

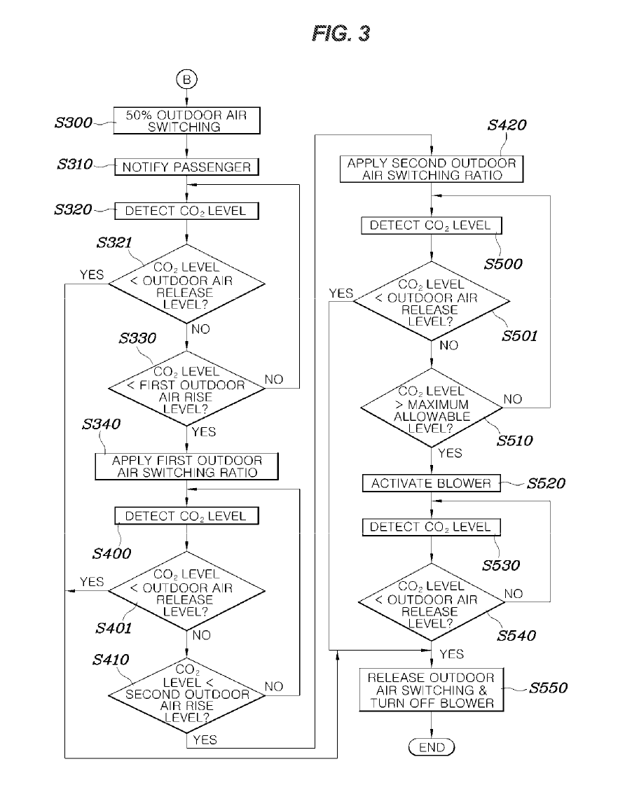

FIG. 1, FIG. 2, and FIG. 3 are flowcharts illustrating an automobile ventilation method, according to various embodiments of the present invention, including detecting a carbon dioxide level inside the vehicle at step S120, determining a current vehicle speed if the carbon dioxide level is greater than a set level at step S140, performing forced outdoor air switching by applying different outdoor air switching ratios for the determination of whether the current vehicle speed is greater or less than a set vehicle speed at steps S200 and S300, detecting a carbon dioxide level inside the vehicle at steps S220 and S500, and comparing the detected carbon dioxide level with a predetermined maximum allowable level, which is greater than the set level, at steps S240 and S510; and activating a blower or increasing air flow if the carbon dioxide level exceeds the maximum allowable level at steps S250 and S520.

More specifically, before the operation S120 of detecting a carbon dioxide level, whether the blower of the vehicle is currently activated may be determined at step S100, and if the blower is not currently activated, the operation S120 of detecting a carbon dioxide level may be performed. The reason for determining whether the blower is activated is to avoid performing the operation S120 of detecting a carbon dioxide level or the forced outdoor air switching operations S200 and S300 unnecessarily while the blower is in the active state under which the carbon dioxide level may not be deemed greater than the set level.

Meanwhile, the operation S100 of determining whether the blower is activated may further include detecting a current vehicle speed and determining whether the current vehicle speed is greater than a predetermined reference speed at step S110, and if the vehicle speed is greater than the predetermined reference speed, the operation S120 of detecting a carbon dioxide level may be performed. The reference speed may have any value, which is set empirically. For example, the reference speed may be 25 kph.

The reason for performing determination of whether the current vehicle speed is greater than the predetermined reference speed at step S110 is because, if the vehicle enters the outdoor air mode while being parked or driving at a low speed of less than 25 kph, exhaust gas emitted from the vehicle itself and other nearby vehicles may come inside the vehicle, creating an unpleasant environment for passengers of the vehicle. This may drop the merchantable quality of the vehicle, so it is preferable to perform the operation S120 of detecting a carbon dioxide level only when the vehicle speed is greater than the reference speed.

In the meantime, if the current vehicle speed is greater than the predetermined reference speed at step S110, the current indoor humidity of the vehicle may be detected at step S111.

Specifically, before the operation S120 of detecting a carbon dioxide level is performed, the indoor humidity level may be detected at step S111 while the vehicle is not parked or stopped, and it is determined whether the detected indoor humidity level is greater than a set humidity level at step S112.

If the current indoor humidity level is greater than the set humidity level, forced outdoor air switching is performed at step S113. The passenger may be notified through a speaker, a display screen, an instrument panel, etc. that the vehicle has just entered the outdoor air mode, at step S114. The vehicle is then switched into a front windshield blow mode to direct the airflow to the front windshield, at step S115, and the blower is activated at step S116.

If the current indoor humidity level is less than the set humidity level, there is no need to separately adjust the humidity level and thus the process directly goes to the operation S120 of detecting a carbon dioxide level.

In the meantime, by performing the notification operation S114 to let the driver know about the forced outdoor air switching, driver inconvenience due to the forced outdoor air switching may be reduced.

After the blower is activated at step S119, a humidity level is detected again at step S117 and compared with the set humidity level at step S118. If the detected humidity level is less than the set humidity level, the operation S120 of detecting a carbon dioxide level is performed. Otherwise, if the detected humidity level is greater than the set humidity level, the blower may be kept activated until the humidity level drops down to the set humidity level.

If it is determined that the detected humidity level is less than the set humidity level at step S118, the process may go directly to the operation S120 of detecting a carbon dioxide level because there is no need to activate the blower for eliminating the moisture on the front windshield.

As such, automatic air circulation is performed by detecting a humidity level in the vehicle without the driver's manual manipulation, thereby eliminating the need to turn on the air conditioner (A/C) to remove the moisture on the front windshield. As a result, the fuel efficiency of the vehicle may be improved while clear visibility for the driver may be secured.

In the meantime, if the detected humidity level is less than the set humidity level, the operation S120 of detecting a carbon dioxide level is performed and the indoor carbon dioxide level is compared with the set level at step S130. If the indoor carbon dioxide level is greater than the set level, a current vehicle speed is detected at step S140.

The detected vehicle speed is compared with a predetermined vehicle speed set empirically at step S150. At steps S200 and S300, forced outdoor air switching may be performed by applying different outdoor air switching ratios for the determination of whether the current vehicle speed is greater or less than the set vehicle speed.

Specifically, in the forced outdoor air switching operations S200 and S300, if the current vehicle speed compared with the set vehicle speed at step S150 is greater than the set vehicle speed, the forced outdoor air switching may be performed with the outdoor air switching ratio of 100% (operation 200); and if the current vehicle speed is less than the set vehicle speed, the forced outdoor air switching may be performed with the outdoor air switching ratio of 50% (operation 300).

The term ‘outdoor air switching ratio’ as herein used refers to a ratio of outdoor air to indoor air inside the vehicle, and the outdoor air switching ratio of 100% means that only the outdoor air is to take up the inside of the vehicle while the outdoor air switching ratio of 50% means that air inside the vehicle needs to consist of outdoor air and indoor air at a 1:1 ratio.

As shown in FIG. 2, in the case the forced outdoor air switching is performed with the outdoor air switching ratio of 100%, as at step S200, the passenger may be notified through a speaker, a display screen, an instrument panel, etc. that the vehicle has just entered the forced outdoor air mode with the outdoor air switching ratio of 100% at step S210, and the blower may be activated at step S250.

In this regard, prior to performing the operation S250 of activating the blower and after the notification operation S210 is performed, an indoor carbon dioxide level of the vehicle may be detected again at step S220 and compared with an outdoor air release level, which is an ideal indoor carbon dioxide level, at step S230. If the carbon dioxide level detected again is greater than the outdoor air release level, the carbon dioxide level may be compared with the predetermined maximum allowable level at step S240.

The term ‘outdoor air release level’ as herein used refers to an indoor carbon dioxide level that does not cause drowsiness or stuffiness to the driver but makes the driver feel comfortable, thereby eliminating the need for the forced outdoor air switching.

Further, the maximum allowable level means maximum allowable indoor carbon dioxide concentration inside the vehicle. This maximum allowable level refers to a level where no more reduction in indoor carbon dioxide concentration is achieved by the forced outdoor air switching, in which case the inside carbon dioxide level (concentration) may be reduced by activating the blower and forcedly inhaling the outdoor air.

On the other hand, if the carbon dioxide level detected again is less than the outdoor air release level, the process ends by turning off the blower and releasing the forced outdoor air switching at step S280.

After the blower is activated at step S250, the indoor carbon dioxide level is detected again at step S260 and compared with the outdoor air release level at step S270. If the carbon dioxide level detected again is less than the outdoor air release level, the forced outdoor air mode need not be kept any longer and thus the process ends by turning off the blower and releasing the forced outdoor air switching at step S280.

The reason for setting the outdoor air switching ratio to 100% when the vehicle speed is high is because of the structures of indoor and outdoor air ducts. Specifically, for reference, air pressure applied to the vehicle is very high while the vehicle is driving at high speed, and accordingly, there is also a large amount of air flowing into the vehicle and incoming outdoor air may flow backward into an indoor air duct at a point where the outdoor air duct and the indoor air duct join. This means that there may be outdoor air flowing backward not through a normal path but through an abnormal path, which makes the passenger mistake it for a fault, which degrades the merchantable quality of the vehicle. Accordingly, shutting the indoor air path with the outdoor air switching ratio of 100% may prevent the outdoor air from flowing backward into the indoor air duct, thereby improving the merchantable quality.

On the other hand, as shown in FIG. 3, forced outdoor air switching may be performed with the outdoor air switching ratio of 50%, at step S300. An indoor carbon dioxide level (or concentration) may then be detected at step S320 and compared with first outdoor air rise level at step S330. If the indoor carbon dioxide level is greater than the first outdoor air rise level, forced outdoor air switching may be performed with a predetermined first outdoor air switching ratio that corresponds to the first outdoor air rise level at step S340.

More specifically, after the forced outdoor air switching may be performed with the outdoor air switching ratio of 50%, the passenger may be notified through a speaker, a display screen, an instrument panel, etc. that the vehicle has just entered the forced outdoor air mode with the outdoor air switching ratio of 50% at step S310, and an indoor carbon dioxide level of the vehicle may be detected at step S320 and compared with the outdoor air release level at step S321.

If the detected carbon dioxide level is less than the outdoor air release level, it means that the forced outdoor air switching need not be kept any longer and thus the process ends by turning off the blower and releasing the forced outdoor air switching at step S550.

Otherwise, if the detected carbon dioxide level is greater than the outdoor air release level, the carbon dioxide level may be compared with the first outdoor air rise level at step S330. If the indoor carbon dioxide level is greater than the first outdoor air rise level, forced outdoor air switching may be performed with a predetermined first outdoor air switching ratio that corresponds to the first outdoor air rise level at step S340.

The first outdoor air rise level may be greater than the set level.

In other words, the indoor carbon dioxide level reaching the first outdoor air rise level implies that indoor carbon dioxide concentration may not be reduced sufficiently only with the outdoor air switching ratio of 50% (in a case there are many passengers and thus emission of carbon dioxide increases) and thus the indoor carbon dioxide concentration may be efficiently reduced by setting the outdoor air switching ratio to be greater than 50%, e.g., to 60% or 70% to inhale more outdoor air.

In the meantime, after the forced outdoor air switching is performed with the first outdoor air switching ratio at step S340, an indoor carbon dioxide level is detected again at step S400 and compared with a second outdoor air rise level at step S410. If the indoor carbon dioxide level is greater than the second outdoor air rise level, forced outdoor air switching may be performed with a predetermined second outdoor air switching ratio that corresponds to the second outdoor air rise level, at step S420.

More specifically, an indoor carbon dioxide level of the vehicle is detected at step S400 and compared with the outdoor air release level at step S401.

If the detected carbon dioxide level is less than the outdoor air release level, it means that the forced outdoor air switching need not be kept any longer and thus the process ends by turning off the blower and releasing the forced outdoor air switching at step S550.

Otherwise, if the detected carbon dioxide level is greater than the outdoor air release level, the carbon dioxide level may be compared with the second outdoor air rise level at step S410. If the indoor carbon dioxide level is greater than the second outdoor air rise level, forced outdoor air switching may be performed with a predetermined second outdoor air switching ratio that corresponds to the second outdoor air rise level, at step S420.

The second outdoor air rise level may be greater than the first outdoor air rise level.

Accordingly, the second outdoor air switching ratio may be greater than the first outdoor air switching ratio, e.g., 80% or 90%, which may lead to efficient reduction in indoor carbon dioxide concentration.

The first and second outdoor air rise levels and the corresponding first and second outdoor air switching ratios may be arranged in a data map in advance. Similarly, third and fourth outdoor air rise levels and corresponding third and fourth outdoor air switching ratios may further be arranged to gradually increase the outdoor air switching ratio until the detected carbon dioxide level does not exceed the predetermined maximum allowable level.

In the meantime, after the forced outdoor air switching is performed with the second outdoor air switching ratio at step S420, an indoor carbon dioxide level may be detected again at step S500 and compared with an outdoor air rise level at step S501. If the indoor carbon dioxide level is greater than the outdoor air release level, the indoor carbon dioxide level may be compared with the predetermined maximum allowable level at step S510.

If the detected carbon dioxide level is less than the outdoor air release level, it means that the forced outdoor air switching need not be kept any longer and thus the process ends by turning off the blower and releasing the forced outdoor air switching at step S550.

If the indoor carbon dioxide level is greater than the predetermined maximum allowable level at step S510, the blower is activated at step S520. Again, an indoor carbon dioxide level is detected at step S530 and the blower is kept activated at step S520 until the indoor carbon dioxide level is less than the outdoor air release level.

After that, when the indoor carbon dioxide level drops below the outdoor air release level, the process ends by turning off the blower and releasing the forced outdoor air switching at step S550.

As such, if the current vehicle speed is less than the set vehicle speed, the vehicle may properly respond to the indoor carbon dioxide level of the vehicle by performing forced outdoor air switching while gradually increasing the outdoor air switching ratio, without need to activate the blower. In addition, if the difference in temperature between indoor and outdoor of the vehicle is large e.g., in wintertime, gradually increasing the outdoor air ratio to be blended with indoor air may help the passenger gradually adapt to the outdoor air or may gradually adjust the incoming outdoor air to the temperature inside the vehicle.

An automobile ventilation method in accordance with the present invention eliminates moisture that appears on the front windshield and side windows by automatically activating the blower, thereby increasing the passenger's convenience.

It also improves the fuel efficiency because there is no need to turn on the A/C to eliminate the moisture.

Furthermore, with the method, carbon dioxide levels are automatically detected and always kept at a proper level with activation of the blower, thereby preventing the driver from becoming drowsy and keeping the indoor air pleasant.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof It is intended that the scope of the invention be defined by the Claims appended hereto and their equivalents.

What is claimed is:

1. An automobile ventilation method, comprising
detecting a first carbon dioxide level inside a vehicle;
detecting a current vehicle speed when the first carbon dioxide level is greater than a predetermined set level, and performing forced outdoor air switching when the current vehicle speed is greater than a predetermined set vehicle speed; and
detecting a second carbon dioxide level inside the vehicle and activating a blower or increasing airflow when the second carbon dioxide level detected inside the vehicle exceeds a predetermined maximum allowable level, which is greater than the predetermined set level.

2. The automobile ventilation method of claim 1, wherein the forced outdoor air switching is performed even when the current vehicle speed is less than the predetermined set vehicle speed, with an outdoor air switching ratio different from that applied during the forced outdoor air switching performed when the current vehicle speed is greater than the predetermined set vehicle speed.

3. The automobile ventilation method of claim 1, further comprising: determining whether the blower is currently activated before detecting the carbon dioxide level; and performing detection of the first carbon dioxide level when the blower is not currently activated.

4. The automobile ventilation method of claim 3, wherein determining whether the blower is currently activated comprises determining whether the current vehicle speed is greater than a predetermined reference speed.

5. The automobile ventilation method of claim 4, wherein determining whether the current vehicle speed is greater than the predetermined set vehicle speed comprises detecting a current indoor humidity level inside the vehicle when the current vehicle speed is greater than the predetermined reference speed.

6. The automobile ventilation method of claim 5, further comprising performing forced outdoor air switching and activating the blower when the current indoor humidity level inside the vehicle is greater than a predetermined set humidity level.

7. The automobile ventilation method of claim 2, wherein performing the forced outdoor air switching comprises performing the forced outdoor air switching with the outdoor air switching ratio of 100%, when the current vehicle speed is greater than the predetermined set vehicle speed.

8. The automobile ventilation method of claim 2, wherein performing the forced outdoor air switching comprises performing the forced outdoor air switching with the outdoor air switching ratio of 50% when the current vehicle speed is less than the predetermined set vehicle speed.

9. The automobile ventilation method of claim 8, further comprising:
detecting a third carbon dioxide level inside the vehicle after performing the forced outdoor air switching with the outdoor air switching ratio of 50%; and
performing the forced outdoor air switching with a predetermined first outdoor air switching ratio that corresponds to a first outdoor air rise level when the detected indoor carbon dioxide level is greater than the first outdoor air rise level.

10. The automobile ventilation method of claim 9, further comprising:
detecting a fourth carbon dioxide level in the vehicle after performing the forced outdoor air switching with the first outdoor air switching ratio; and
performing the forced outdoor air switching with a predetermined second outdoor air switching ratio that corresponds to a second outdoor air rise level when the detected indoor carbon dioxide level is greater than the second outdoor air rise level.
